(19) United States
(12) Patent Application Publication
(10) Pub. No.: US 2016/0258538 A1
(43) Pub. Date: Sep. 8, 2016

(54) VALVE SEAT, SEALING GASKET AND PRESSURE VALVE

(71) Applicant: FISHER JEON GAS EQUIPMENT (CHENGDU) CO., LTD., Chengdu, Sichuan (CN)

(72) Inventor: Dan Liu, Shenzhen (CN)

(73) Assignee: EMERSON PROCESS MANAGEMENT REGULATOR TECHNOLOGIES, INC., Mckinney, TX (US)

(21) Appl. No.: 15/033,033

(22) PCT Filed: Oct. 29, 2014
(86) PCT No.: PCT/IB14/03003

§ 371 Date: Apr. 28, 2016

(30) Foreign Application Priority Data
Oct. 29, 2013 (CN) 201320699158.3

(51) Int. Cl. F16K 1/42; F16K 1/46

(52) U.S. Cl. CPC F16K 1/42; F16K 1/465

(57) ABSTRACT

The present disclosure relates to a valve seat, a sealing gasket and a pressure valve. The valve seat comprises a valve seat body. A groove used for containing the sealing gasket is arranged on the valve seat body. At least one side of the groove is sunken inwards into an inclined groove shape. The valve seat with the design can prevent the sealing gasket from being damaged under a high pressure, thereby avoiding poor sealing performance; meanwhile, the valve seat is convenient to be machined and low in cost.

### TECHNICAL FIELD

The present invention relates to a valve seat arrangement for use with process control valves, to a process control valve having such a valve seat arrangement, and to a method of making such a valve seat arrangement.

### TECHNICAL BACKGROUND

Generally, a process control valve 13 includes a valve seat arrangement 15. Typically, the process control valve is open at times and closed at times, with FIG. 1 showing the process control valve 14 in a closed position. The valve seat arrangement 15 of FIG. 1 includes a valve seat body 10 and a sealing gasket 11. Generally, the valve seat body 10 is made of a metallic material, and the sealing gasket 11 is made of a nonmetallic material, such as an elastomeric material with a certain rebound elasticity. Under normal circumstances, the sealing gasket 11 is disposed in a groove 17 formed in the valve seat body 10, and is tightly adhered and attached onto the valve seat body 10. When the valve is in the open position, the sealing gasket 11 is in contact with process medium flowing through the process control valve 15, and hence the valve seat arrangement 15, including the sealing gasket 11, needs to bear the pressure of the process medium. On the other hand, when the process control valve 15 is closed, part of the sealing gasket 11 is in contact with medium on the upstream side 12, thus bearing the inlet pressure of the medium. When the inlet pressure on the upstream side 12 is high, an upstream portion 11a of the sealing gasket 11 has to withstand the high pressure, while a downstream portion 11b is only exposed to outlet pressure on a downstream side 18. When the process control valve 13 is closed, the sealing gasket 11, and the upstream portion 11a, is exposed in the process medium and bears static pressure. Thus, obvious elastic deformation is produced. However, because the valve seat body 10 is made of the metallic material, the valve seat body is not deformed under pressure. When the pressure of the medium is high, the sealing gasket 11, especially the upstream portion 11a, may be deformed, deflected, or otherwise shifted or torn away from a contact position with groove 17 of the valve seat body 10 (for example, see FIG. 2A, FIG. 2B and FIG. 2C), thus causing potential leakage between the flow control element E and the valve seat arrangement 15.

On such a background, those skilled in the art have attempted to make an improvement. As shown in FIG. 3, a partial schematic view of another valve seat arrangement includes a valve seat body 20, and a groove 21 on the valve seat body 20. The groove 21 is a horizontal groove which cut or otherwise formed to one side in a radial direction. When a sealing gasket is assembled in the groove, the area available for adhering and attaching the sealing gasket to the valve seat body 20 can be increased. Hence, the compression area of the sealing gasket is decreased, the sealing gasket is not easily torn away or otherwise deformed or deflected and thereby damaged, and thus the valve seat is prevented from leaking under a high pressure. However, during the machining of the valve seat with the design, an internal groove cutter 22 needs to be used. If the size of the notch of the valve seat is small, machining cannot be conducted.

Therefore, the existing valve seat needs to be improved, so as to achieve the goals of convenience in machining and low cost on the premise that the sealing performance of the valve seat under a high pressure is improved.

### SUMMARY OF THE DISCLOSURE

In order to solve the above-mentioned problem, the present disclosure provides a valve seat, which has the advantages that a sealing gasket of the valve seat is not easily torn away from a valve seat body under a high pressure to cause leakage, the structure is simple, the valve seat is convenient to be machined and machining interference is avoided.

Said valve seat comprises a valve seat body, a groove used for containing a sealing gasket is arranged on said valve seat body and at least one side of said groove is sunken inwards into an inclined groove shape.

Preferably, said groove of the valve seat comprises a first part and a second part which mutually form an angle, said first part is an inclined groove which is inclined downwards on one side of said valve seat body and said second part is a horizontal groove.

Preferably, said groove of the valve seat comprises a first part and a second part which mutually form an angle, said first part of said groove is an inclined groove which is inclined downwards respectively on both sides of said valve seat body and said second part is a horizontal groove.

Preferably, the longitudinal section of the first part of said groove of the valve seat is in the shape of an inclined rectangle, triangle or semicircle.

Preferably, said sealing gasket of the valve seat is made of a nonmetallic material.

Preferably, said sealing gasket of the valve seat is made of rubber, plastic or graphite.

Preferably, said valve seat body of the valve seat is made of a metallic material.

The present disclosure further provides a sealing gasket which is contained in a groove of any said valve seat, and the shape of said sealing gasket is consistent with the shape of said groove.

The present disclosure further provides a pressure valve, which comprises any said valve seat.

The design of the groove of the valve seat of the present disclosure enables the valve seat to have better sealing performance, the sealing gasket is not easily torn away from the valve seat body under a high pressure to cause leakage, the design structure of the groove of the valve seat is simple, a turning tool can be used for direct machining, the valve seat is convenient to be machined and machining interference is also avoided.

Further, the first part of the groove of the valve seat of the present disclosure can be inclined downwards to one side or both sides of said valve seat body; on the basis of convenient machining, the adhering and attaching area of said sealing gasket and said valve seat body can be increased and the sealing gasket is prevented from being torn away to cause leakage.

The shape of the sealing gasket of the present disclosure is consistent with the shape of the groove on said valve seat body, fully fills said groove and is matched with said valve seat body to play a role of a soft seal.

The valve seat of the present disclosure substantially solves the technical problem of tight closing of the valve under a high pressure, the high-pressure sealing reliability of the soft seal valve seat is also improved, especially the structure of the valve seat is simple, the valve seat is convenient to be machined, the cost is low and the valve seat can be widely applied to valves which need to be tightly closed.

### DESCRIPTION OF THE DRAWINGS

FIG. 1 is a schematic view, including a partial enlargement, of a valve and a valve seat of the prior art;

FIG. 2A, FIG. 2B and FIG. 2C are respectively partial plan views of the valve seat shown in FIG. 1;

FIG. 3 is a partial schematic view of another valve seat in the prior art;

FIG. 4 is a stereoscopic view of a valve seat of one embodiment of the present disclosure;

FIG. 5 is a sectional view of the valve seat shown in FIG. 4;

FIG. 6 is a sectional view of a valve seat of one embodiment of the present disclosure;

FIG. 7 is a partial schematic view of a valve seat body shown in FIG. 6;

FIG. 8 is a partial schematic view of the valve seat shown in FIG. 6;

FIG. 9A and FIG. 9B are respectively machining schematic views of the valve seat body of the present disclosure;

FIG. 10 is a schematic view, including a partial enlargement, of a pressure valve of one embodiment of the present disclosure.

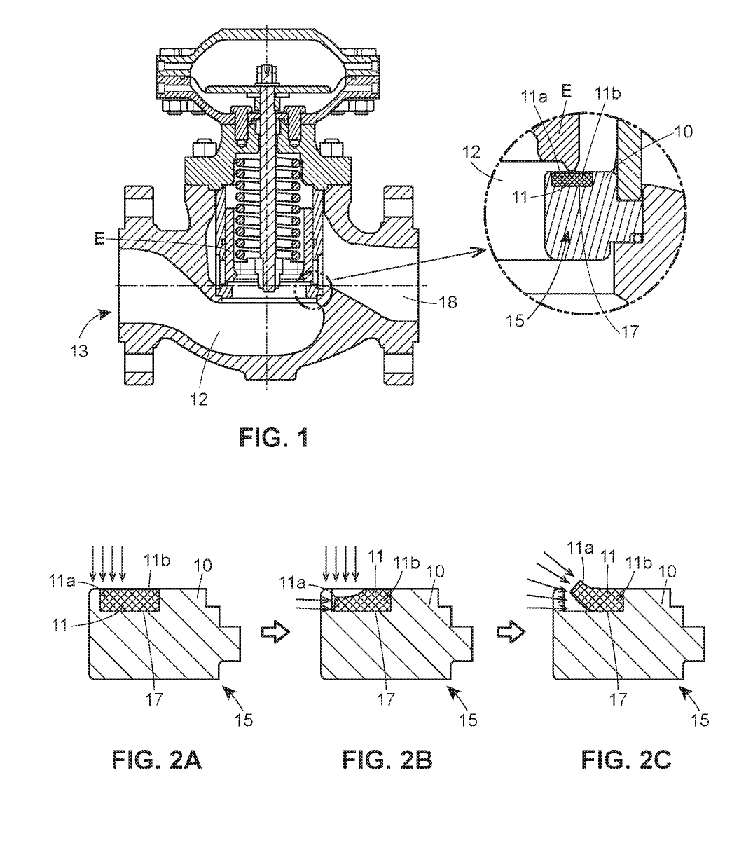

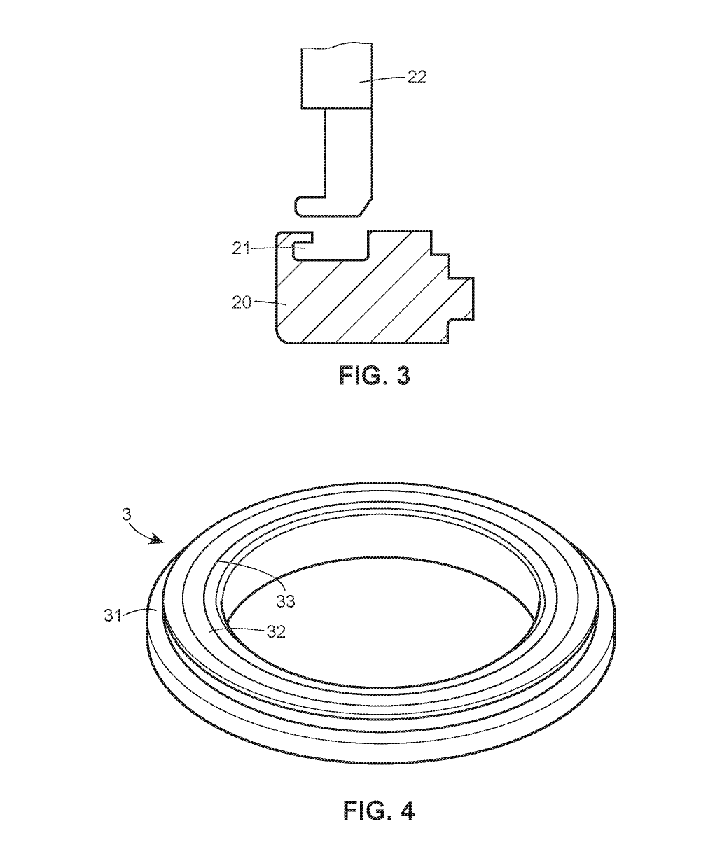

### DESCRIPTION OF THE EMBODIMENTS

The following description of preferred embodiments is exemplary only and should absolutely not be considered as limitation to the present disclosure and application or usage thereof.

A valve seat provided by the present disclosure comprises a valve seat body, a groove used for containing a sealing gasket is arranged on said valve seat body and at least one side of said groove is sunken inwards into an inclined groove shape; when said groove and said sealing gasket are in an assembled state, most area of said sealing gasket is in said groove, thus the compression area of said sealing gasket is decreased, the adhering and attaching area of the sealing gasket and said valve seat body is increased simultaneously, and the sealing gasket is prevented from being damaged under a high pressure to cause poor sealing performance and leakage; at the same time, the structure of said valve seat with the inclined groove structure is simple and the valve seat is convenient to be machined.

The technical scheme of the present disclosure is further described below in combination with drawings and specific embodiments.

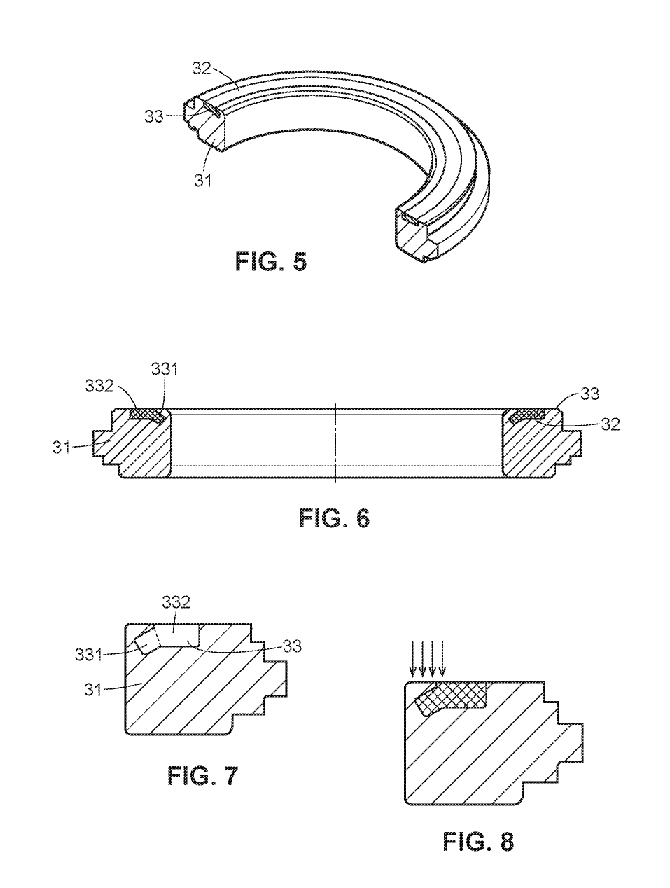

FIG. 4 shows a valve seat 3 of one embodiment of the present disclosure, the valve seat 3 comprises a valve seat body 31 and a sealing gasket 32 in the valve seat body, said valve seat can be matched with a control element 43 to realize the opening and the closing of the process control valve 115, and said sealing gasket is used for realizing soft sealing of the valve seat. Specifically, an annular groove 33 is arranged on said valve seat body 31, said sealing gasket 32 is arranged in said groove 33, the shape of said sealing gasket 32 is consistent with the shape of said groove 33, said sealing gasket 32 is tightly adhered in said groove 33, and the upper surface of said sealing gasket bears medium pressure. In combination with FIG. 5, said groove 33 is provided with an inclined groove which is inclined towards the internal part of the valve seat body 31, thus the adhering and attaching area of said sealing gasket 32 and said valve seat body 31 is increased, the compression area of the sealing gasket in said groove is simultaneously decreased, especially part of the sealing gasket on a high-pressure side is wrapped in said groove, said sealing gasket is prevented from being damaged under a high pressure to cause leakage, the groove is convenient to be designed and machined and the machining cost can be reduced.

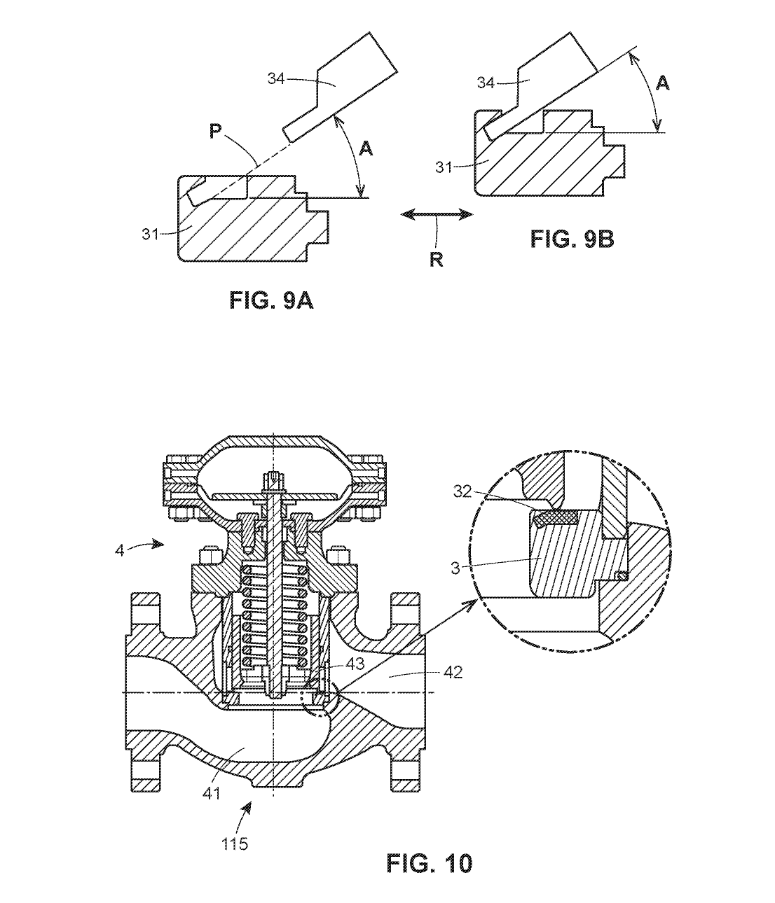

Specifically, FIG. 6 shows a sectional view of said valve seat, the groove 33 on said valve seat body 31 comprises a first part 331 and a second part 332, said first part 331 is an inclined groove which is inclined downwards on one side of said valve seat body, and said second part 332 is a horizontal groove oriented parallel to a radial direction R (see, for example, FIGS. 9A and 9B). Said sealing gasket 32 is tightly adhered in the groove 33 on said valve seat body 31, thus the adhering and attaching area of said sealing gasket 32 and said valve seat body 31 is increased and the sealing gasket 32 is enabled to be not easily damaged under a high pressure. When a valve port is closed, if the inner side of the sealing gasket is in a high-pressure medium, since the groove on the valve seat body is provided with the inclined groove which extends towards the inner side of the internal part of the valve seat body, the design can enable the sealing gasket on the high-pressure side to be wrapped in the groove, the compression area of the sealing gasket is decreased and the sealing gasket is prevented from being damaged to cause leakage. Optionally, when the outer side of said sealing gasket is in the high-pressure medium, the groove on said valve seat body can extend towards the outer side of the internal part of the valve seat body to enable the sealing gasket on the high-pressure side to be wrapped in the groove.

FIG. 7 shows a partial view of the valve seat body, said groove 33 comprises a first part 331 which obliquely extends towards the internal part of said valve seat body and a second part 332 which horizontally extends towards the valve seat body 31, said second part 332 specially can be a rectangular inclined groove which is inclined downwards, the inclined groove can be machined by using a groove cutter on a common lathe, a machining tool is not interfered, a special forming process is not needed and the machining cost is not increased.

The section of said second part in the embodiment is in the shape of a rectangle. It should be understood that, in order to facilitate machining, the section of said second part can also be in other shapes such as triangle or semicircle which are easy to be machined.

Optionally, said first part can also extend towards the both sides of the internal part of the valve seat body, thus the adhering area of said sealing gasket and sand valve seat body is further increased and the inclined groove is also very convenient to be designed and machined.

FIG. 8 shows a partial view of the valve seat body and the sealing gasket under a high pressure. Since the valve seat body is generally made of a metallic material and said sealing gasket is an elastic rubber product, when the high-pressure side of said sealing gasket is fully wrapped in said groove, the compression area of the sealing gasket can be decreased, the adhering and attaching area of the sealing gasket and the valve seat body is simultaneously increased and the sealing gasket is prevented from being torn off under a high pressure to cause leakage.

FIG. 9A and FIG. 9B respectively show machining schematic views of the valve seat body of the present disclosure. In FIG. 9A, the inclined groove of said valve seat body 31 can allow a cutter 34 to be fed and retracted along the angle of a feeding path P (as shown by a dotted line in the figure), the design of the inclined groove on said valve seat body enables the feeding path and the cutter itself not be intersected with the valve seat body except the inclined groove, and thus no machining interference is caused. FIG. 9B shows the cutter 34 which is in a state of opening the inclined groove in the valve seat body 31, the angle of the inclined groove is also the angle A of the feeding path of the cutter, and specifically, the angle of the inclined groove can be determined according to the size of the opening of the groove. The valve seat with the design can be machined through a common lathe and a common groove cutter, and the cost is low.

Another embodiment of the present disclosure further discloses a sealing gasket. The sealing gasket is matched with the valve seat in the embodiment above to enable said valve to have higher soft sealing performance. Specifically, said sealing gasket is contained in the groove of said valve seat, the shape of the sealing gasket is adaptively consistent with the shape of the groove of said valve seat and said sealing gasket is tightly adhered in said groove. The shape of said groove enables the adhering area of said sealing gasket and the groove to be increased, the high pressing bearing area is simultaneously decreased and the sealing performance of the product is improved.

Further, said sealing gasket can be made of a nonmetallic material such as rubber, plastic, polyurethane, graphite or asbestos which has better sealing performance.

Another embodiment of the present disclosure further discloses a pressure valve, the pressure valve comprises any valve seat of the embodiments above and can be used for places where tightly closing is needed, the technical problem of high-pressure tight closing of the valve is solved and the soft sealing reliability of the soft seal valve seat is greatly improved.

FIG. 10 shows a partial schematic view of a pressure valve 4 of the present embodiment and said valve seat 3, wherein said pressure valve 4 comprises an inlet chamber 41, an outlet chamber 42 and a control element E assembly which is arranged between said inlet chamber 41 and said outlet chamber 42, wherein said control element assembly comprises a valve seat 3 and a control element 43. When said pressure valve 4 is in a working state, said inlet chamber 41 contains high-pressure medium; when said control element 43 and said valve seat 3 are matched to close the valve, the top end of said spool 43 is in contact with the sealing gasket on said valve seat to achieve a sealing effect, one part of the sealing gasket 32 on said valve seat 3 is in contact with the high-pressure medium in the inlet chamber 41 and bears a high pressure and the other part of the sealing gasket 32 is in contact with a low-pressure medium in the outlet chamber; at the moment, one end of the sealing gasket on the high-pressure side is inwards sunken into the internal part of said valve seat 3, thus the contact area of the sealing gasket and the high-pressure medium is enabled to be smaller, phenomena such as damage are not easily occur and said pressure valve is prevented from leaking.

Optionally, the groove of said valve seat 3 can also be provided with downwards inclined grooves on both sides, thus the both sides of the sealing gasket are enabled to be wrapped in said valve seat, the compression area of the sealing gasket is further decreased, the adhering and attaching area of the sealing gasket and the valve seat is increased and thus the sealing gasket is enabled not to be easily torn away from the valve seat to cause leakage.

On one hand, the pressure valve of the present disclosure solves the technical problem of high-pressure tight closing of the valve and simultaneously improves the reliability of the soft seal valve seat under a high pressure; on the other hand, the valve seat of the pressure valve of the present disclosure also has the advantages of simple structure, convenience in machining, low cost and the like, and is suitable for batch production.

The purposes of providing exemplary embodiments are to enable the disclosure to be more complete and to comprehensively convey the protection range to those skilled in the art. Numerous details such as examples of specific parts, devices and methods are described to provide comprehensive understanding of the embodiments of the disclosure. It is very obvious to those skilled in the art, details are not necessarily provided, and exemplary embodiments can be implemented in numerous different forms and should not be interpreted as limitation to the range of the disclosure. In some exemplary embodiments, well-known processes, device structures and techniques are not described in details.

Even though terms such as ‘first’, ‘second’ and ‘third’ can be used herein for describing various elements, components or parts, these elements, components or parts should not be limited by these terms; these terms may be only used for distinguishing an element, a component or a part. When terms such as ‘first’, ‘second’ and other numerical terms are used herein, unless otherwise clearly specified in the context, the terms do not contain any sequence or order. Therefore, under the situation of not departing from the description of the exemplary embodiments, following said first element, first component and first part can be interpreted as terms ‘first element’ , ‘first component’ and ‘first part’.

Even though various embodiments of the present disclosure have been described herein in details, it should be understood that the present disclosure is not limited to the specific embodiments which are described and shown herein in details. Under the situation of not departing from the spirit and the scope of the present disclosure, those skilled in the art can make other modifications and variations. All these modifications and variations should fall into the range of the present disclosure. Moreover, all components described herein can be replaced by other technically equivalent components.

1. A valve seat assembly for use on a process control valve, comprising:
a valve seat body;
a groove formed in the valve seat body and sized to contain a sealing gasket;
at least a portion of the groove being sunken into the valve seat body at an angle relative to a radius of the valve seat body.

2. The valve seat according to claim 1, wherein the groove comprises a first part and a second part which mutually form an angle, wherein the first part is an inclined groove which is inclined downwards on one side of the valve seat body and the second part is a horizontal groove.

3. The valve seat according to claim 1, wherein the groove comprises a first part and a second part which mutually form an angle, the first part of the groove is an inclined groove which is inclined downwards respectively on both sides of the valve seat body and the second part is a horizontal groove.

4. The valve seat according to claim 3, wherein a longitudinal section of the first part of the groove is in the shape of an inclined rectangle, triangle or semicircle.

5. The valve seat according to claim 1, wherein the sealing gasket is made of a nonmetallic material.

6. The valve seat according to claim 5, wherein the sealing gasket is made of rubber, plastic or graphite.

7. The valve seat according to claim 1, wherein the valve seat body is made of a metallic material.

8. A sealing gasket according to claim 1, wherein the sealing gasket is arranged to conform to the shape of the groove.

9. A process control valve, comprising:
an inlet;
an outlet;
a control element;
a valve seat assembly, the valve seat assembly including:
a valve seat body;
a groove formed in the valve seat body and sized to contain a sealing gasket;
at least a portion of the groove being sunken into the valve seat body at an angle relative to a radius of the valve seat body.
